(19) United States
(12) Patent Application Publication
(10) Pub. No.: US 2025/0199397 A1
(43) Pub. Date: Jun. 19, 2025

(54) Mask Stitching for Extreme Ultraviolet Lithography

(71) Applicant: Synopsys, Inc., Sunnyvale, CA (US)

(72) Inventors: Robert Michal Iwanow, Portland, OR (US); Zachary Adam Levinson, Rochester, NY (US); Kevin Dean Lucas, Austin, TX (US); James Erwin Burdorf, Durham, NC (US)

(21) Appl. No.: 18/540,796

(22) Filed: Dec. 14, 2023

(51) Int. Cl. G03F 1/70; G06F 30/398; G06F 119/18

(52) U.S. Cl. CPC G03F 1/70; G06F 30/398; G06F 2119/18

(57) ABSTRACT

A first location within a mask pattern of a semiconductor circuit layout is determined, based on a feature of the mask pattern that is within a threshold distance of a boundary in the mask pattern. The mask pattern is based on a first mask exposure and a second mask exposure that meet at the boundary. The first location defines where to place a first assistive feature that reduces a sensitivity to lithographic process variations of the feature of the mask pattern. A second location of the mask pattern is also determined. The second location defines where to place a second assistive feature that reduces stray light at the boundary during the first mask exposure and the second mask exposure. The mask pattern is then modified to place the first assistive feature in the first location and the second assistive feature in the second location.

### TECHNICAL FIELD

The present disclosure relates generally to the fabrication of semiconductor devices, and relates more particularly to methods for stitching masks to minimize irregularities in the boundary region between the masks.

### BACKGROUND

Extreme ultraviolet (EUV) lithography is an optical lithography technique that is used to fabricate a semiconductor device based on a semiconductor circuit layout. EUV lithography uses EUV wavelengths (e.g., near 13.5 nanometers (nm)) and a laser-pulsed tin (Sn) droplet plasma to produce a desired pattern, by using a reflective photomask to expose a substrate covered by photoresist.

High numerical aperture (high-NA) EUV lithography is a particular type of EUV lithography in which the numerical aperture of the EUV system (which may be 0.33 for some EUV systems) is increased to 0.55. The higher numerical aperture allows the projection of smaller spot sizes and smaller pitches (e.g., as much as sixty percent smaller than can be achieved using a system with an aperture of 0.33), making high-NA EUV lithography ideal for lower process technology nodes (e.g., the 2 nm node and below).

### SUMMARY

A non-transitory computer readable medium includes stored instructions, which when executed by a processor, cause the processor to determine a first location within a mask pattern of a semiconductor circuit layout, based on a feature of the mask pattern that is within a threshold distance of a boundary in the mask pattern. The mask pattern is based on a first mask exposure and a second mask exposure that meet at the boundary. The first location is a location in which to place a first assistive feature that reduces a sensitivity to lithographic process variations of the feature of the mask pattern. A second location of the mask pattern is also determined. The second location is a location in which to place a second assistive feature that reduces stray light at the boundary during the first mask exposure and the second mask exposure. The mask pattern is then modified to place the first assistive feature in the first location and the second assistive feature in the second location.

A method includes determining a location of a mask pattern of a semiconductor circuit layout in which to place an assistive feature, based on a feature of the mask pattern that is within a threshold distance of a boundary in the mask pattern. The mask pattern based on a first mask exposure and a second mask exposure that meet at the boundary. The assistive feature reduces a sensitivity to lithographic process variations of the feature of the mask pattern. The mask pattern is then modified to place the assistive feature in the location.

A system includes a memory storing instructions and a processor, coupled with the memory and to execute the instructions, the instructions when executed cause the processor to relocate a feature that is within a threshold distance of a boundary in a mask pattern of a semiconductor circuit layout. The mask pattern is based on a first mask exposure and a second mask exposure that meet at the boundary. The feature defines a location of an electrical interconnect or a transistor. The instructions when executed further cause the processor to determine a location of the mask pattern in which to place an assistive feature. The assistive feature reduces stray light at the boundary during the first mask exposure and second mask exposure. The instructions when executed further cause the processor to modify the mask pattern to place the assistive feature in the location. The instructions when executed further cause the processor to perform a mechanical reinforcement of the assistive feature.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example method for performing stitching of masks for use in extreme ultraviolet lithography, according to examples of the present disclosure;

FIG. 2 illustrates one example of a feature of a mask pattern that has been partially relocated due to the feature crossing the boundary between a first portion of a substrate to be exposed during a first mask exposure and a second portion of the substrate to be exposed during a second mask exposure;

FIG. 3 illustrates some example assistive features that may be added to a mask pattern that requires a plurality of mask exposures to print on a substrate;

FIG. 4 illustrates several examples of mechanically reinforced patterns that may be deployed to form the second assistive feature described in connection with FIG. 2 and illustrated in FIG. 3;

FIG. 5 depicts a flowchart of various processes used during the design and manufacture of an integrated circuit in accordance with some embodiments of the present disclosure; and

FIG. 6 depicts a diagram of an example computer system in which embodiments of the present disclosure may operate.

### DETAILED DESCRIPTION

Aspects of the present disclosure relate to mask stitching for extreme ultraviolet lithography. As discussed above, high-NA EUV lithography is a particular type of EUV lithography in which the numerical aperture of the EUV system (which may be 0.33 for some EUV systems) is increased to 0.55. The higher numerical aperture allows the projection of smaller spot sizes and smaller pitches (e.g., as much as sixty percent smaller than can be achieved using a system with an aperture of 0.33), making high-NA EUV lithography ideal for lower process technology nodes (e.g., the 2 nm node and below).

High-NA EUV scanners may image a pattern on a photomask onto a substrate with a demagnification of 4X in one orientation and a demagnification of 8X in the other orientation. This asymmetric demagnification forces such high-NA EUV scanners to have a maximum exposure field size of 26 mm×16.5 mm. This is half the exposure field size of non-high-NA lithographic scanners, which have a maximum exposure field size of 26 mm×33 mm. This also means that in order to pattern a layer of a semiconductor chip design that is larger than 26 mm×16.5 mm using high-NA EUV lithography, the patterning process will need to be performed in two separate mask exposures which are subsequently stitched or joined together. As a result, the boundary region where the two exposure fields that are stitched together meet (which may extend across the entire semiconductor chip) may be exposed twice during the lithography process. This double exposure can cause process variations and defects in the boundary region, particularly when the boundary region includes relatively small or denser features.

Examples of the present disclosure minimize process variations and defects in substrates that require two or more mask exposures to transfer a complete mask pattern to the substrate during a lithography process. In some examples, process variations and defects are minimized by placing assistive features in a mask pattern that has been defined. The assistive features may include features that, when exposed on the substrate, will reduce the sensitivity of features of the mask pattern that are patterned on the substrate in the boundary region to process variations and will reduce stray light. In further examples, original features of the mask pattern, which may define areas where interconnects or transistors are to be fabricated on the substrate, may be relocated and/or resized in the boundary region to minimize undesirable patterning issues in the pattern. Thus, in short, examples of the present disclosure provide various modifications to a mask pattern that requires printing in multiple mask exposures, where the modifications allow for better printing of the mask pattern features on the substrate.

Technical advantages of the present disclosure include the ability to perform high-precision lithographic processes that require multiple mask exposures to pattern a single substrate (such as high-NA EUV lithographic processes), without sacrificing precision in the boundary regions where the multiple mask exposures meet or overlap. Thus, the advantages of high-NA EUV may be realized with fewer process variations and defects caused by the multiple mask exposures. Further technical advantages of the present disclosure improve the functionality of a computer system used to design mask patterns of semiconductor circuit layouts by improving the accuracy with which the processor of the computing system places features of mask patterns for lower process technology nodes.

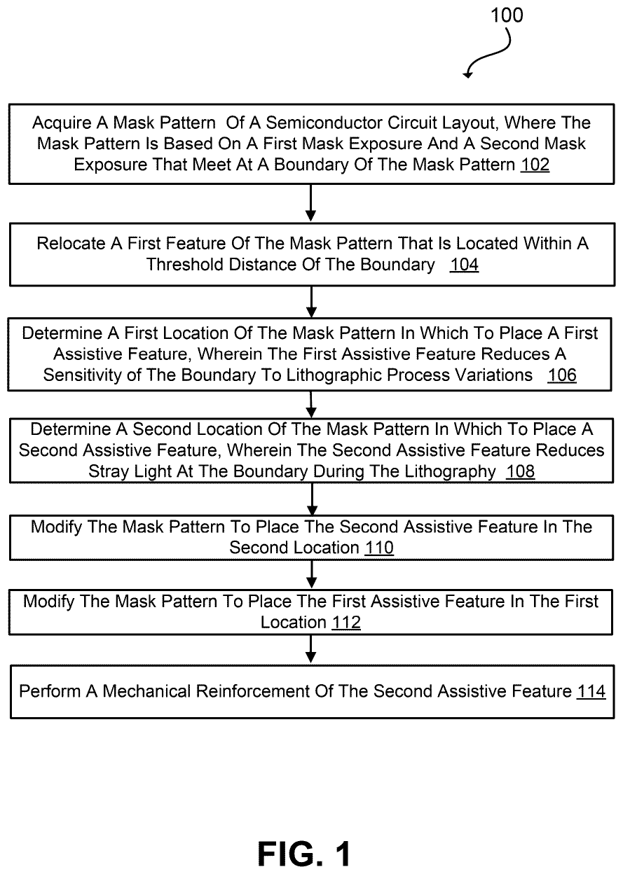

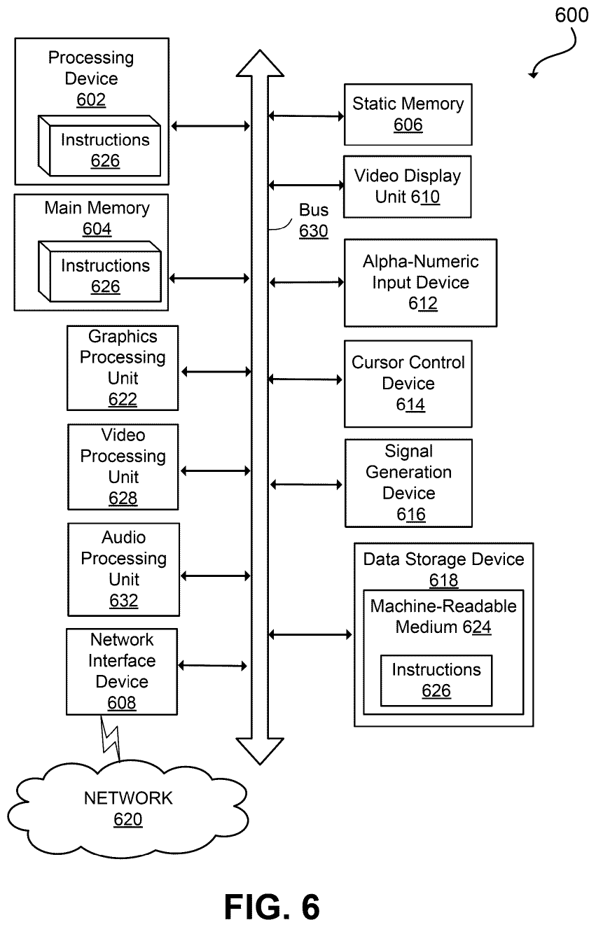

FIG. 1 illustrates an example method 100 for performing stitching of masks for use in extreme ultraviolet lithography, according to examples of the present disclosure. In one example, all or some of the steps of the method 100 may be performed by components of an EUV system, such as a high-NA EUV system. In other examples, all or some of the steps of the method 100 may be performed by a processing device of a computer system, such as the computer system 600 illustrated in FIG. 6. For the sake of example, steps of the method 100 are described below as being performed by a processing system, where the processing system may be part of an EUV system, part of a computer system, or part of another device.

At 102, the processing system acquires a mask pattern of a semiconductor circuit layout, where the mask pattern is based on a first mask exposure and a second mask exposure that meet at a boundary of the mask pattern. For instance, where lithography of a layer of the semiconductor circuit is to be performed using a high-NA EUV lithography process, at least two mask exposures (i.e., at least the first mask exposure and the second mask exposure) may be needed to pattern the full substrate (e.g., silicon wafer) surface on which the mask pattern is to be printed. For instance, if the full exposed substrate surface is approximately 26 mm×33 mm, then at least two mask exposures, each of which exposes an area of the substrate of approximately 26 mm×16.5 mm, would need to be performed (since high-NA EUV cannot pattern an area that is larger than 26 mm×16.5 mm in a single mask exposure). As discussed above, this may result in some portions of the substrate surface being exposed more than once.

At 104, the processing system relocates a first feature of the mask pattern that is located within a threshold distance of the boundary (where the boundary is located between a first portion of the substrate to be exposed during the first mask exposure and a second portion of the substrate to be exposed during the second mask exposure). In one example, a feature of the mask pattern may correspond to a portion of the substrate surface that is to be etched or removed during the lithography of the layer. For instance, the portion of the substrate surface may be etched or removed to create a space for fabrication of an interconnect or a transistor on the layer.

In one example, the boundary includes the area of the substrate in which the results of the first mask exposure and the second mask exposure are stitched together (i.e., aligned to form a single continuous pattern on the substrate). In a further example, the boundary may extend beyond the area where the results of the first mask exposure and the second mask exposure are stitched (e.g., to either side of a line where the results of the first mask exposure meet the results of the second mask exposure). In one example, the location of the boundary may be explicitly acquired during acquisition of the mask pattern at 102.

In one example, the threshold distance from the boundary is defined prior to execution of the method 100. The value of the threshold distance may be configurable by a user, such as a designer of the semiconductor circuit or an operator of a lithography system used to perform the lithography of the layer. For instance, depending upon the type or use case of the semiconductor circuit, or the capabilities of the lithography system used to perform the lithography of the layer, wider or narrower distances between the boundary and features of the mask pattern may be tolerated.

In some cases, the actual distance from the first feature to the boundary may be zero. For instance, the first feature may reside partially in the first portion of the substrate and partially in the second portion of the substrate. Put another way, the first feature may intersect or cross the boundary. In one example, any feature that crosses the boundary will be at least partially relocated. Relocating may involve not only moving a portion of the first feature, but also resizing and/or changing the shape of a portion of the first feature for improved printability in the boundary area.

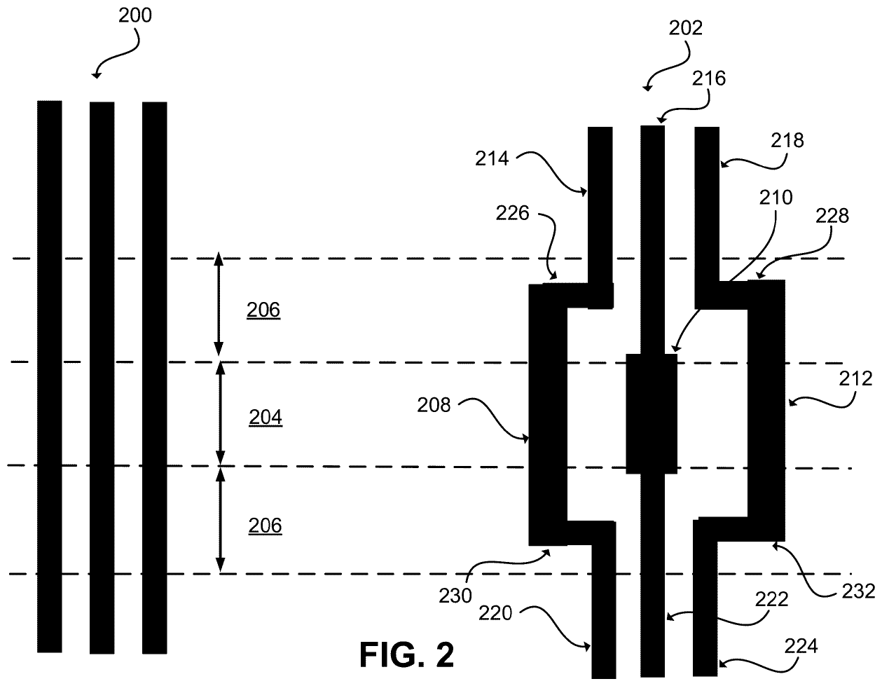

FIG. 2 illustrates one example of a feature 200 of a mask pattern that has been partially relocated due to the feature 200 crossing the boundary between a first portion of a substrate to be exposed during a first mask exposure and a second portion of the substrate to be exposed during a second mask exposure. In one example, a stitching zone 204 is defined around the area where the first mask exposure (e.g., the portion of FIG. 2 residing above the stitching zone 204) and the second mask exposure (e.g., the portion of FIG. 2 residing below the stitching zone 204) meet. The stitching zone 204 may represent the portion of the substrate that would be exposed twice during lithography (e.g., once during the first mask exposure and once during the second mask exposure). In addition, a buffer zone 206 may be defined both above and below the stitching zone 204. The buffer zone 206 represents an area of the substrate that is unlikely to be exposed more than once during lithography; however, the buffer zone 206 may help to define an area in which feature continuity can be maintained, as described in further detail below.

As illustrated in FIG. 2, the feature 200, which in this example represents an area of the substrate in which a plurality of interconnects is to be formed, crosses the stitching zone 204. The portions of the feature 200 that reside within the stitching zone 204 may thus be exposed during both of the first mask exposure and the second mask exposure. However, the feature 200 may be at least partially relocated as shown by the modified feature 202 in order to accommodate potential patterning issues in the feature 200 due to the double exposure. More specifically, the portions 208, 210, and 212 of the feature 200 that reside within the stitching zone 204 may be relocated to be spaced further apart, as shown by the modified feature 202. The wider widths of the portions 208, 210, and 212 reflect the fact that these portions 208, 210, and 212 are exposed twice, during both the first mask exposure and the second mask exposure. Thus, spacing the portions 208, 210, and 212 further apart allows for these wider widths to be accommodated. The amounts by which the widths of the portions 208, 210, and 212 are widened, as well as the degree of spacing therebetween, may depend at least in part on the density of other features that are part of the mask pattern. Portions 214, 216, 218, 220, 222, and 224 of the feature 200, which do not reside within the stitching zone 204, may be left as originally defined. Assistive portions 226, 228, 230, and 232 may be added to the modified feature 202 in the buffer zones 206 to join the relocated portions 208, 210, and 212 to the portions 214, 216, 218, 220, 222, and 224 that are not relocated.

By spacing the relocated portions 208, 210, and 212 of the feature 200 further apart in the modified feature 202, the risk of the relocated portions 208, 210, and 212 bleeding into each other when the relocated portions 208, 210, and 212 suffer patterning imperfections due to double exposure can be minimized. This helps to ensure robust electrical performance for the interconnects that will eventually be fabricated in the space defined by the modified feature 202. In one example, placement and routing rules may limit the number of adjacent parallel lines that can be relocated in the manner illustrated. In a further example, the placement and routing rules may also limit the definition of vias and routing metal in the opposite orientation to the parallel lines (e.g., perpendicular to the feature 200 illustrated in FIG. 2) in the stitching zone 204.

In one example, 104 may be skipped if there are no features in the mask pattern that are close enough to (e.g., within the threshold distance from) the boundary to be at risk of being exposed more than once. In this case, the method 100 may proceed directly from 102 to 106.

Referring back to FIG. 1, at 106, the processing system determines a first location of the mask pattern in which to place a first assistive feature, wherein the first assistive feature reduces a sensitivity of the feature of the mask pattern to lithographic process variations (e.g., process variations of the first mask exposure and the second mask exposure). In one example, the first assistive feature is a feature that is not part of the mask pattern acquired at 102 and that will not resolve or print on the substrate during the lithography. The first assistive feature is designed to provide a good process window for the lithography of the substrate by reducing the sensitivity of the feature of the mask pattern to lithographic process variations.

In one example, the first location is a location that is proximal to (e.g., within a threshold length of) a feature of the mask pattern. In one example, the first location may be identified using lithographic simulations of the mask pattern, which predict the impact of lithographic process variations upon a feature of the mask pattern.

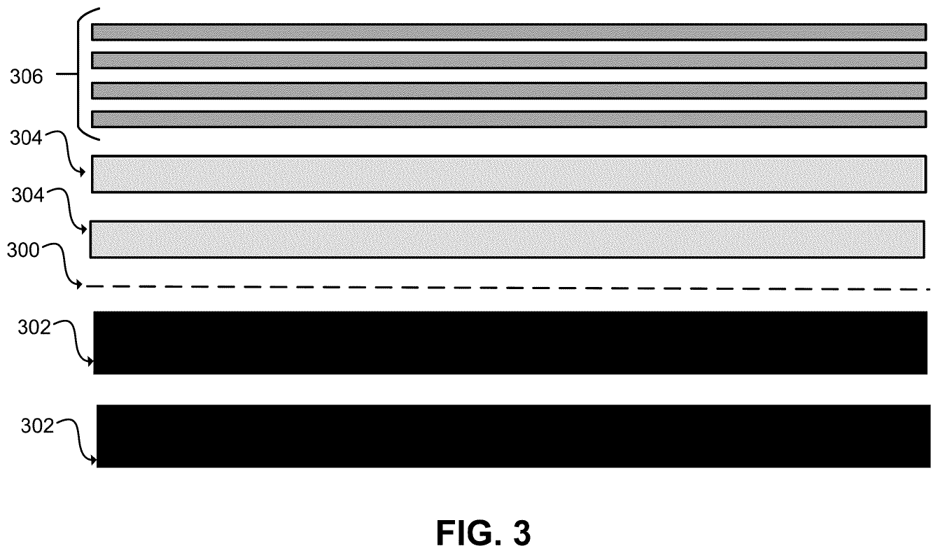

FIG. 3 illustrates some example assistive features that may be added to a mask pattern that requires a plurality of mask exposures to print on a substrate. More specifically, FIG. 3 shows the stitching line 300 where a first mask exposure region of a mask pattern (e.g., represented by the region above the stitching line 300) and a second mask exposure region of the mask pattern (e.g., represented by the region below the stitching line 300) meet. As illustrated one or both of the first mask exposure region and the second mask exposure region may include features 302 to be patterned on a substrate, such as interconnects or transistors. In the example illustrated in FIG. 3, the illustrated features 302 do not cross the stitching line 300; however, the features 302 may be positioned close enough to the stitching line 300 that portions of the features 302 are exposed more than once during lithography.

To mitigate the sensitivity of the features 302 to lithographic process variations caused by either a single exposure or multiple exposures, a first assistive feature may be added to the mask pattern. In one example, the first assistive feature includes one or more rectangular regions 304 that are added to the mask pattern, near the stitching line 300. These rectangular regions 304 may be oriented in a direction that is parallel to the stitching line 300. In one example, the first location for at least one of the rectangular regions is positioned adjacent to, but spaced apart from, one of the features 302. That is, there may be no other features (e.g., original or added assistive features) between a rectangular region 304 and at least one feature 302. Although the example first assistive feature illustrated in FIG. 3 is rectangular in shape, it will be appreciated that assistive features such as the first assistive feature may have any shape, including square and curvilinear shapes.

Referring back to FIG. 1, at 108, the processing system determines a second location of the mask pattern in which to place a second assistive feature, wherein the second assistive feature reduces stray light at the boundary during the lithography (e.g., during the first mask exposure and the second mask exposure). In one example, the second assistive feature is a feature that is not part of the mask pattern acquired at 102 and that will not resolve or print on the substrate during the lithography. The second assistive feature is designed to reduce stray light occurring as a result of the at least two mask exposures at the boundary.

In one example, the second assistive feature is placed in a location that is adjacent to the first location, where the first location is positioned between the second location and a feature of the mask pattern. In one example, the second location may be identified using a flare simulation or a mask pattern density computation (e.g., locally or long range). The flare simulation may co-optimize placement of the second assistive feature with placement of the black border edge of the mask pattern (where the black border edge may be all-angle, or curvilinear to reduce stress on the mask).

Referring again to FIG. 3, the second assistive feature may include a diffraction grating pattern 306. As shown in FIG. 3, the diffraction grating pattern 306 may be oriented in a direction that is substantially parallel to the stitching line 300. However, the diffraction grating pattern 306 may be positioned so that the diffraction grating pattern 306 is separated from the features 302 (and from the stitching line 300) by the rectangular region(s) 304 of the first assistive feature. In another example, the diffraction grating pattern 306 may be oriented in a direction that is perpendicular to the direction of 8X demagnification in an EUV scanner.

It should be noted that although FIG. 3 illustrates the second assistive feature as a diffraction grating including a plurality of bars, the second assistive feature may have an all-angle or a curvilinear shape to either reduce flare on the wafer or maintain a more constant flare. The impacts of different shapes and/or locations for the second assistive feature on flare may be computed using an electromagnetic field effect-aware (M3D) mask simulation tool.

The second assistive feature may be sized, shaped, and located in a manner that ensures both reliable printing of the second assistive feature and reduction of stray light without negatively impacting the sensitivity of the mask pattern features to lithographic process variations.

At 110, the processing system modifies the mask pattern to place the second assistive feature in the second location.

At 112, the processing system modifies the mask pattern to place the first assistive feature in the first location (e.g., after the second assistive feature has been placed at 110).

In one example, placing the first assistive feature after placing the second assistive feature may allow the first assistive feature to be blended into the second assistive feature. For instance, placing the second assistive feature may utilize the pitch of the first assistive feature, but shrink the pitch further away from the first assistive feature. Put another way, if the second assistive feature includes a diffraction grating pattern as illustrated in FIG. 3, then the portion of the diffraction grating that is positioned closer to the first assistive feature may share the same pitch as the first assistive feature, and the pitch may gradually shrink for the portions of the diffraction grating that are positioned further away from the first assistive feature. This blending of the first assistive feature and the second assistive feature may reduce negative diffraction effects in the area where the first assistive feature transitions into the second assistive feature.

In one example, the first assistive feature may be placed in the first location from within a first software control script. The second assistive feature may be placed in the second location from within the same first software control script or from within a second control script. However placing both the first and second assistive features from within the same software control script allows the first and second assistive features to potentially be placed simultaneously. Thus, in some examples, 112 can be performed prior to 110, or 110 and 112 can be performed in parallel.

At 114, the processing system performs a mechanical reinforcement of the second assistive feature. Due to its small dimensions, the second assistive feature may be mechanically fragile, especially if fabricated as illustrated in FIG. 3, where the pieces of the diffraction grating pattern 306 are long and thin. Mechanical stress effects in the substrate may contribute to patterning failure (e.g., collapse or lift-off) of the second assistive feature. In some examples, the second assistive feature may be mechanically reinforced or altered to improve stability.

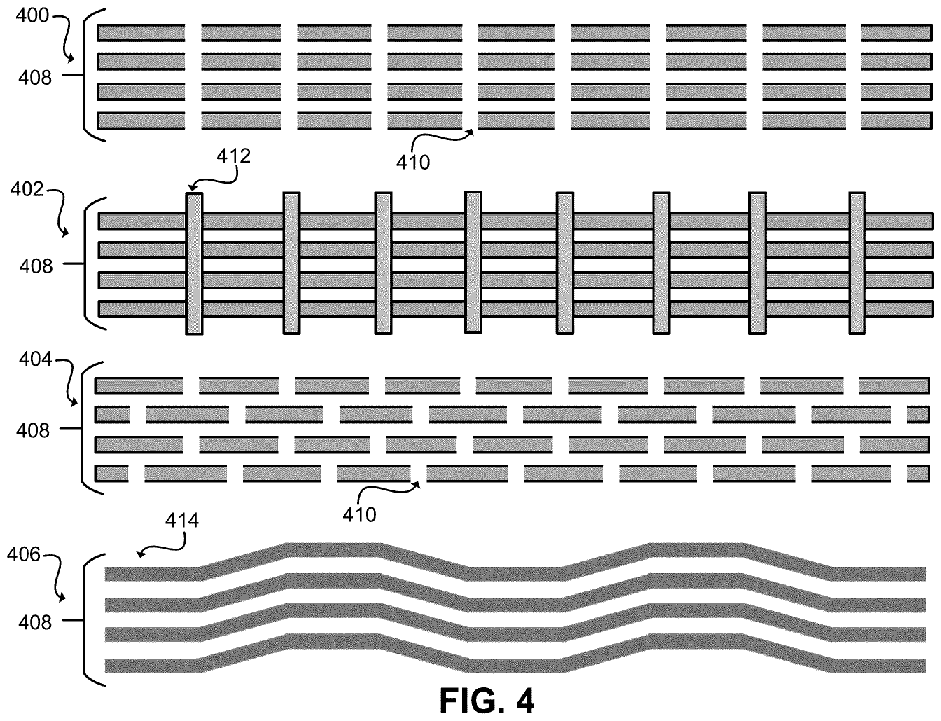

FIG. 4 illustrates several examples of mechanically reinforced patterns 400, 402, 404, and 406 that may be deployed to form the second assistive feature described in connection with FIG. 2 and illustrated in FIG. 3. As illustrated in FIG. 4, each mechanically reinforced pattern 400, 402, 404, and 406 may include at least a first plurality of parallel bars 408 that are oriented parallel to each other. The first plurality of parallel bars 408 may further be oriented parallel to the boundary or stitching line of the mask pattern. The first plurality of parallel bars 408 may be reinforced in any one or more of a number of ways.

For instance, the mechanically reinforced pattern 400 illustrates an example in which each bar of the first plurality of parallel bars 408 is broken up into a plurality of shorter bars that are spaced collinearly along the length of each bar. Put another way, each bar of the first plurality of parallel bars 408 may include a plurality of gaps 410 along its length (a single gap 410 is labeled in FIG. 4 for ease of illustration).

In the mechanically reinforced pattern 400, the gaps 410 are positioned in the same location along each bar of the first plurality of parallel bars 408. That is, each gap 410 is aligned, linearly, with gaps 410 in all of the other bars of the first plurality of parallel bars 408. Alternatively, the plurality of gaps 410 may be positioned in a staggered manner, as shown in the example mechanically reinforced pattern 404. In the example of the mechanically reinforced pattern 404, each gap 410 may be aligned, linearly, with the gap in one other bar of the first plurality of parallel bars 408; gaps 410 in the remaining bars of the first plurality of parallel bars 408 may be aligned differently.

By printing each bar of the first plurality of parallel bars 408 as a line of shorter bars, mechanical stress effects (which have been demonstrated to affect long, thin, straight features more than shorter features or features which include turns or jogs) on the second assistive feature can be reduced.

The mechanically reinforced pattern 402 illustrates an example in which a second plurality of parallel bars is positioned in a substantially perpendicular orientation relative to the first plurality of parallel bars 408 (a single bar 412 of the second plurality of parallel bars is labeled in FIG. 4 for ease of illustration). In this case, the bars 412 in the second plurality of parallel bars are spaced apart from each other along the lengths of the first plurality of parallel bars 408. Moreover, each bar 412 in the second plurality of parallel bars may intersect every bar of the first plurality of parallel bars 408. The bars 412 of the second plurality of parallel bars act as mechanical stabilizers for the first plurality of parallel bars 408.

In another example, the bars 412 in the second plurality of parallel bars may be shortened, so that each bar 412 in the second plurality of parallel bars intersects exactly one bar in the first plurality of parallel bars 408 rather than intersecting every bar in the first plurality of parallel bars 408. Using shorter bars 412 would allow the spacing between the bars 412 in the second plurality of parallel bars to be staggered.

The mechanically reinforced pattern 406 illustrates an example in which the plurality of parallel bars 414 do not take the form of straight lines (as in the mechanically reinforced patterns 400, 402, and 404), but rather take forms that are partially angled or curved. This partially angled or curved shape exhibits improved mechanical stability relative to a diffraction grating pattern in which the bars all take the form of straight lines. Moreover, the partially angled or curved shape is also better at reducing stray light relative to a diffraction grating pattern in which short bars are all positioned in a parallel and uniform orientation.

In other examples, a mechanically reinforced pattern for the diffraction grating may simply include patterning the diffraction grating with fewer bars (e.g., fewer than four bars in the first plurality of parallel bars 408), but making each of the bars wider. Moreover, rather than employing straight bars or bar segments, the mechanically reinforced pattern may employ bar segments with bends or jogs.

After 114, additional processing of the mask pattern may be performed in accordance with optical proximity correction (OPC) and/or inverse lithography (ILT) techniques to optimize the relocated and assistive features of the mask pattern. In one example, OPC and/or ILT may include modifying at least one of: a shape, a size, or a location of an assistive feature that was placed at 110 or 112. This additional processing may be performed in an iterative fashion until a target or result is achieved (e.g., a desired shape, size, or location of an assistive feature).

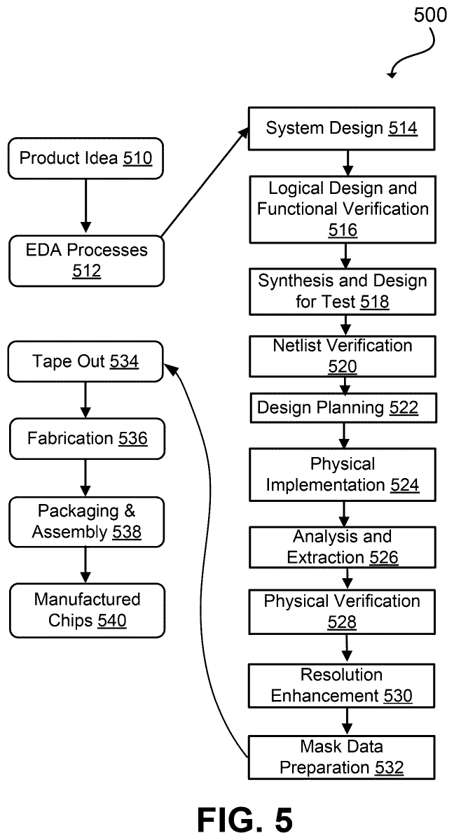

FIG. 5 illustrates an example set of processes 500 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 510 with information supplied by a designer, information which is transformed to create an article of manufacture that uses a set of EDA processes 512. When the design is finalized, the design is taped-out 534, which is when artwork (e.g., geometric patterns) for the integrated circuit is sent to a fabrication facility to manufacture the mask set, which is then used to manufacture the integrated circuit. After tape-out, a semiconductor die is fabricated 536 and packaging and assembly processes 538 are performed to produce the finished integrated circuit 540.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 5. The processes described by be enabled by EDA products (or EDA systems).

During system design 514, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 516, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 518, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 520, the netlist is checked for compliance with timing constraints and for correspondence with the HDL code. During design planning 522, an overall floor plan for the integrated circuit is constructed and analyzed for timing and top-level routing.

During layout or physical implementation 524, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 526, the circuit function is verified at the layout level, which permits refinement of the layout design. During physical verification 528, the layout design is checked to ensure that manufacturing constraints are correct, such as DRC constraints, electrical constraints, lithographic constraints, and that circuitry function matches the HDL design specification. During resolution enhancement 530, the geometry of the layout is transformed to improve how the circuit design is manufactured.

During tape-out, data is created to be used (after lithographic enhancements are applied if appropriate) for production of lithography masks. During mask data preparation 532, the ‘tape-out’ data is used to produce lithography masks that are used to produce finished integrated circuits.

A storage subsystem of a computer system (such as computer system 600 of FIG. 6) may be used to store the programs and data structures that are used by some or all of the EDA products described herein, and products used for development of cells for the library and for physical and logical design that use the library.

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable medium) on which is stored one or more sets of instructions 626 or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A non-transitory computer readable medium comprising stored instructions, which when executed by a processor, cause the processor to:
determine a first location within a mask pattern of a semiconductor circuit layout in which to place a first assistive feature based on a feature of the mask pattern that is within a threshold distance of a boundary in the mask pattern,
wherein the mask pattern is based on a first mask exposure and a second mask exposure that meet at the boundary, and
wherein the first assistive feature reduces a sensitivity to lithographic process variations of the feature of the mask pattern;
determine a second location of the mask pattern in which to place a second assistive feature, wherein the second assistive feature reduces stray light at the boundary during the first mask exposure and the second mask exposure;
modify the mask pattern to place the second assistive feature in the second location; and
modify the mask pattern to place the first assistive feature in the first location, after modifying the mask pattern to place the second assistive feature.

2. The non-transitory computer readable medium of claim 1, wherein both the first assistive feature and the second assistive feature comprise features that do not resolve during the first mask exposure and the second mask exposure.

3. The non-transitory computer readable medium of claim 1, wherein the feature of the mask pattern defines a location of an interconnect or a transistor.

4. The non-transitory computer readable medium of claim 3, wherein the first assistive feature comprises a region that is oriented in a direction substantially parallel to the boundary.

5. The non-transitory computer readable medium of claim 1, wherein the second location is positioned so that the first assistive feature is positioned between the boundary and the second assistive feature.

6. The non-transitory computer readable medium of claim 5, wherein the second assistive feature comprises a diffraction grating pattern that is oriented in a direction substantially parallel to the boundary.

7. The non-transitory computer readable medium of claim 6, wherein the processor performs a mechanical reinforcement of second assistive feature.

8. The non-transitory computer readable medium of claim 7, wherein the diffraction grating pattern comprises a first plurality of substantially parallel bars.

9. The non-transitory computer readable medium of claim 8, wherein each bar of the plurality of substantially parallel bars comprises a plurality of shorter bars oriented in a collinear manner, and wherein the processor performs the mechanical reinforcement that comprises defining a gap between each pair of the plurality of shorter bars.

10. The non-transitory computer readable medium of claim 8, wherein the processor performs the mechanical reinforcement that comprises positioning a second plurality of substantially parallel bars in a perpendicular orientation relative to the first plurality of substantially parallel bars.

11. The non-transitory computer readable medium of claim 10, wherein each bar of the second plurality of substantially parallel bars intersects one or more bars of the first plurality of substantially parallel bars.

12. The non-transitory computer readable medium of claim 1, wherein the stored instructions further cause the processor to:
relocate the feature of the mask pattern that is located within the threshold distance of the boundary.

13. The non-transitory computer readable medium of claim 12, wherein relocating the feature comprises modifying at least one of: a location, a size, or a shape of a portion of the feature.

14. The non-transitory computer readable medium of claim 13, wherein the feature includes a plurality of lines defining where a plurality of electrical interconnects are to be fabricated, and the relocating comprises adjusting a spacing between portions of the plurality of lines that cross a zone that is defined within the threshold distance of either side of the boundary.

15. The non-transitory computer readable medium of claim 1, wherein the processor executes a single control script to control a placement of the first assistive feature and the second assistive feature.

16. The non-transitory computer readable medium of claim 1, wherein the mask pattern is modified to place the first assistive feature in the first location after the mask pattern has been modified to place the second assistive feature.

17. A method comprising:
determining a location within a mask pattern of a semiconductor circuit layout in which to place an assistive feature based on a feature of the mask pattern that is within a threshold distance of a boundary in the mask pattern,
wherein the mask pattern is based on a first mask exposure and a second mask exposure that meets at the boundary, and
wherein the assistive feature reduces a sensitivity to lithographic process variations of the feature of the mask pattern; and
modifying the mask pattern to place the assistive feature in the location.

18. The method of claim 17, further comprising:
relocating, prior to the determining the location, the feature of the mask pattern, wherein the feature defines a location of an electrical interconnect or a transistor.

19. A system comprising:
a memory storing instructions; and
a processor, coupled with the memory and to execute the instructions, the instructions when executed cause the processor to:
relocate a feature that is within a threshold distance of a boundary in a mask pattern of a semiconductor circuit layout,
wherein the mask pattern is based on a first mask exposure and a second mask exposure that meets at the boundary, and
wherein the feature defines a location of an electrical interconnect or a transistor;
determine a location of the mask pattern in which to place an assistive feature, wherein the assistive feature reduces stray light at the boundary during the first mask exposure and the second mask exposure;
modify the mask pattern to place the assistive feature in the location; and
perform a mechanical reinforcement of the assistive feature.

20. The system of claim 19, wherein the feature intersects the boundary, and a relocation of the feature comprises modifying at least one of: a location, a size, or a shape of a portion of the feature.
